(19) United States
(12) Patent Application Publication
(10) Pub. No.: US 2022/0167196 A1
(43) Pub. Date: May 26, 2022

(54) Multi-Radio Access Technology Dual Connectivity Support in Minimization Drive Tests

(71) Applicant: Telefonaktiebolaget LM Ericsson (PUBL), Stockholm (SE)

(72) Inventors: Malik Wahaj Arshad, STOCKHOLM (SE); Pradeepa Ramachandra, LINKÖPING (SE); Angelo Centonza, Torrenueva Costa Granada (ES)

(21) Appl. No.: 17/598,356

(22) PCT Filed: Mar. 27, 2020
(86) PCT No.: PCT/SE2020/050316

§ 371 Date: Sep. 27, 2021

Related U.S. Application Data
(60) Provisional application No. 62/825,607, filed on Mar. 28, 2019.

(51) Int. Cl. H04W 24/10; H04W 88/06

(52) U.S. Cl. CPC H04W 24/10; H04W 88/06

(57) ABSTRACT

A method performed by a wireless device includes receiving, from a first network node, a first Minimization Drive Test (MDT) configuration for a secondary cell group and applying the first MDT configuration for the secondary cell group.

### TECHNICAL FIELD

The present disclosure relates, in general, to wireless communications and, more particularly, systems and methods for Multi-Radio Access Technology in Dual Connectivity (MR-DC) support in Minimization of Drive Tests (MDT).

### BACKGROUND

Minimization Drive Tests (MDT) was firstly studied in Rel-9 (TR 36.805) driven by RAN2 with the purpose to minimize the actual drive tests. MDT has been introduced since Rel-10 in LTE. MDT has not been specified for NR in the involved standards in RAN2, RAN3 and SA5 groups.

The use cases in the TR 36.805 include: coverage optimization, mobility optimization, capacity optimization, parameterization for common channels, and Quality of Service (QoS) verification.

Normal radio resource management (RRM) mechanisms only allow for measurements to be reported when the user equipment (UE) has radio resource control (RRC) connection with the particular cell, and there is sufficient uplink (UL) coverage to transport the measurement report. This will restrict measurements to be collected from UEs not experiencing radio link failure (RLF) and experiencing sufficient UL coverage. Besides, there is no accompanying location information in normal RRM measurements.

When MDT was introduced in Release 10, it was decided to include MDT as a part of the Trace function which is able to provide very detailed logging data at call level. Based on the methods of activating/deactivating trace and trace configuration, the trace function can be classified into the following two aspects.
Management activation/deactivation: Trace Session is activated/deactivated in different Network Elements (NE) directly from the Element Manager (EM) using the management interfaces of those NEs.
Signalling Based Activation/Deactivation: Trace Session is activated/deactivated in different NEs using the signalling interfaces between those elements so that the NEs may forward the activation/deactivation originating from the EM.

On the other hand, the MDT can be classified as Area-based MDT and Signalling-based MDT from the use case perspective illustrated below:
Area based MDT: MDT data is collected from UEs in a specified area. The area is defined as a list of cells (Universal Terrestrial Radio Access Network (UTRAN) or Evolved-UTRAN (E-UTRAN)) or as a list of tracking/routing/location areas. The area-based MDT is an enhancement of the management-based trace functionality. Area based MDT can be either a logged MDT or Immediate MDT.
Signalling based MDT: MDT data is collected from one specific UE. The UE that is participating in the MDT data collection is specified as International Mobile Equipment Identity-Software Version (IMEI-SV) or as International Mobile Subscriber Identity (IMSI). The signalling based MDT is an enhancement of the signalling based subscriber and equipment trace. The signalling based MDT can be either a logged MDT or Immediate MDT.

In Long Term Evolution (LTE), for Area based MDT, the MDT control and configuration parameters are sent by the Network Management directly to the eNodeB (eNB). Then, the eNB selects UEs which fulfil the criteria including the area scope and the user consent and starts the MDT. For signaling-based MDT, i.e., UE specific MDT, the MDT control and configuration parameters are sent by the Network Management to MME which then forwards the parameters to eNB associated with the specific UE.

FIG. 1 summarizes the classification of the MDT.

### Location Information

The Logged MDT measurements are tagged by the UE with location data in the following manner:
E-UTRAN Cell Global Identifier (ECGI) or Cell-Id of the serving cell when the measurement was taken is always included.
Detailed location information (e.g. GNSS location information) is included if available in the UE when the measurement was taken. If detailed location information is available, the reporting shall consist of latitude and longitude. Depending on availability, altitude, uncertainty and confidence may be also additionally included. UE tags available detailed location information only once with upcoming measurement sample, and then the detailed location information is discarded, i.e. the validity of detailed location information is implicitly assumed to be one logging interval.

For Immediate MDT, the M1 measurements are tagged by the UE with location data in the following manner:
Detailed location information, such as, for example, Global Navigation Satellite System (GNSS) location information, is included if available in the UE when the measurement was taken. If detailed location information is available, the reporting shall consist of latitude and longitude. Depending on availability, altitude, uncertainty and confidence may be also additionally included.
The UE should include the available detailed location information only once. If the detailed location information is obtained by GNSS positioning method, GNSS time information shall be included. For both event-based and periodic reporting, the detailed location information is included if the report is transmitted within the validity time after the detailed location information was obtained. The validity evaluation of detailed location information is left to UE implementation.

### User Consent Handling

For signalling based MDT, the Core Network (CN) shall not initiate MDT towards a particular user unless the user consent is available.

For area-based MDT, the CN indicates to the Radio Access Network (RAN) whether MDT is allowed to be configured by the RAN for this user considering, e.g. user consent and roaming status, by providing management-based MDT allowed information consisting of the Management Based MDT Allowed indication and optionally the Management Based MDT PLMN List. The management-based MDT allowed information propagates during inter-PLMN handover if the Management Based MDT Public Land Management Network (PLMN) List is available and includes the target PLMN.

The same user consent information can be used for area-based MDT and for signaling-based MDT, i.e. there is no need to differentiate the user consent per MDT type. Collecting the user consent shall be done via customer care process. The user consent information availability shall be considered as part of the subscription data and as such this shall be provisioned to the Home Subscriber Server (HSS) database.

### Dual Connectivity

FIG. 2 illustrates the multiple architecture options available according to Release 15. Currently, release 15 supports up to 7 Architecture options which includes both stand alone and non-standalone scenarios. In this contribution, we would focus on the Architecture options supporting dual connectivity and potential support of MDT in those options, specifically:
Option 3: E-UTRAN New Radio-Dual Connectivity (EN-DC)
Option 4: NR-E-UTRA Dual Connectivity (NE-DC)
Option 7: Next Generation-Dual Connectivity (NGEN-DC)

As part of Multi-RAT-Dual Connectivity (MR-DC) configuration, each UE is configured with two separate scheduled cell groups namely:
Master Cell Group (MCG)
Secondary Cell Group (SCG)
   Master Cell Group (MCG) belongs to the master node called Master Node (MN) and Secondary cell Group belongs to the slave node (SN). Based on the MR-DC type, MN and SN could either be LTE cells or NR cells.

### Bearer Termination Options in MR-DC

An important aspect to understand in MR-DC is the bearer termination. FIG. 3 illustrates bearer termination in MR-DC. Specifically, FIG. 3 illustrates the bearer types based on termination points. There are mainly two types of bearer termination in MR-DC, namely:
MN terminated bearer: in MR-DC, a radio bearer for which PDCP is located in the MN.
SN terminated bearer: in MR-DC, a radio bearer for which PDCP is located in the SN.

This is an important aspect since it would also decide how the network would configure the UE with MDT configuration in MR-DC scenarios.

### MDT Support in MR-DC

When it comes to MDT support in dual connectivity scenarios, we need to start with a few basic considerations, specifically:
Visibility of DC configuration to the Operation, Administration, Management (OAM) and impact on MDT configuration.
Configuration of MDT configuration to UE via MN, SN or both
Trigger type support in MDT for MR-DC

### Visibility of DC Configuration to the OAM and Impact on MDT Configuration

Dual connectivity is need based and configured by the RAN nodes on case by case and UE support basis. OAM is aware about the support for dual connectivity in a specific RAN node but OAM does not have visibility about the dual connectivity configuration on individual UE. So, to support MDT configuration with dual connectivity, OAM needs to provide MDT configuration including configuration for secondary cell group (SCG) cells based on RAN support rather than support of individual UE.

### Configuration of MDT Configuration to UE Via MN SN or Both

The next important aspect is how the MDT configuration with DC consideration is send to the UE. Before assessing the configuration option for MDT in MR-DC scenarios, it is important to assess the measurement quantities currently available in MDT for both logged and immediate MDT as shown in Table 2 below.

Logged MDT only involves UE specific measurements but Immediate MDT involves measurements from both UE and the RAN node, specifically measurements M4-M7 are specific to RAN node.

Thus, specifically for Immediate MDT in MR-DC, we need to configure both RAN nodes contribute towards calculating the MDT measurements.

Now, if we consider the options available to configure the MDT on UE in MR-DC scenarios, there are multiple options available:
MDT configuration is always provided by MN
MDT configuration for MN is provided by MN and SN provides its respective configuration to the UE
Flexible approach for MDT configuration in DC scenarios where SN can be configured to provide MDT configuration based on network preference

The first option that the complete MDT configuration including dual connectivity aspect is always provided by MN is the simplest approach since it avoids the complexity to coordinate between MN and SN on which node would configure the MDT configuration for SN towards the UE. There are some potential issues in case of MN configuring reports for SN on UE including:
MN needs to provide MDT configuration for SN, potentially on another RAT, i.e. NE-DC or EN-DC scenarios. The trigger conditions and the configuration parameters could be different in this case which needs to be supported by MN.
In case of SN terminated bearer, SRB is terminated directly on the SN so in this case, the measurements M4-M7 needs to be specifically measured at SN since the PDCP for SN is separate from MN. If the SN need to report these measurements to MN always, it involves extra overhead in MN-SN signaling and coordination. It might be applicable in split bearer scenario that part of M4-M7 can be measured in the MN since the Packet Data Convergence Protocol (PDCP) is located in MN but then we need to have a separate implementation for both split bearer and SN terminated bearer.

The second and third option provides more flexibility in terms of MN and SN coordination and also cover the scenario of SN terminated bearer measurements. In this case, MN and SN can perform MDT measurements independently but at the cost of more complexity in terms of MN-SN coordination for MDT configuration and also sharing SN MDT reports with MN.

In case of only MN providing configuration for both MN and SN, MN needs to coordinate with SN for collecting measurements M4-M7 in case of SN terminated bearer while it would receive the measurements M1, M2, M3m M8 and M9 directly from the UE. This would extra complexity since depending on if it is split bearer or SN terminated bearer, MN needs to collect different measurements from SN and then merge it into measurements received for SN from UE.

Trigger Type Support in MDT for MR DC

Another aspect to consider is the support for SN related measurements during logged measurements. First a brief overview of the types of MDT based on RRC state.

MDT Types Based on RRC States: Logged MDT and Immediate MDT

In general, there are two types of MDT measurement logging, i.e., Logged MDT and Immediate MDT.

Logged MDT

A UE is configured to perform periodical MDT logging during RRC_IDLE state after receiving the MDT configurations from the network. The UE shall report the DL pilot strength measurements (Reference Signal Received Power (RSRP)/Reference Signal Received Quality (RSRQ)) together with time information, detailed location information if available, and Wireless Local Area Network (WLAN), Bluetooth to the network using the UE information framework when it moves back to RRC_CONNECTED state. The DL pilot strength measurement of Logged MDT is collected based on the existing measurements required for cell reselection purpose, without imposing UE to perform additional measurements.

TABLE 1
The measurement logging for Logged MDT

| MDT | RRC | |
|---|---|---|
| mode | states | Measurement quantities |
| Logged | RRC_IDLE | RSRP and RSRQ of the serving cell and available UE |
| MDT | | measurements for intra-frequency/inter-frequency/inter-RAT, |
| | | time stamp and detailed location information if available. |

Immediate MDT

Measurements for Immediate MDT purpose can be performed by RAN and UE. There are a number of measurements (M1-M9 defined in 3GPP TS 37.320) which are specified for RAN measurements and UE measurements. For UE measurements, the MDT configuration is based on the existing Radio Resource Control (RRC) measurement procedures for configuration and reporting with some extensions for location information.

The measurement quantities for Immediate MDT are shown in Table 2 below.

TABLE 2
The measurement quantities for Immediate MDT

| MDT | RRC | |
|---|---|---|
| mode | states | Measurement quantities |
| Immediate | RRC_CONNECTED | M1: RSRP and RSRQ measurement by UE. |
| MDT | | M2: Power Headroom measurement by UE. |
| | | M3: Received Interference Power measurement by eNB. |
| | | M4: Data Volume measurement separately for DL |
| | | and UL, per QCI per UE, by eNB. |
| | | M5: Scheduled IP Throughput for MDT |
| | | measurement separately for DL and UL, per RAB |
| | | per UE and per UE for the DL, per UE for the UL, |
| | | by eNB. |
| | | M6: Packet Delay measurement, separately for DL |
| | | and UL, per QCI per UE, see UL PDCP Delay, by |
| | | the UE, and Packet Delay in the DL per QCI, by the |
| | | eNB. |
| | | M7: Packet Loss rate measurement, separately for |
| | | DL and UL per QCI per UE, by the eNB. |
| | | M8: RSSI measurement by UE. |
| | | M9: RTT measurement by UE. |

Currently, the UE only measures on the MN cell when it is in Inactive or Idle state so the SN configuration during logged measurements does not add any value.

Based on the above considerations, we would assess the multiple DC scenarios for release 15 below.

Option 3 (aka EN-DC)

This option involves support for configuration of MDT in both E-UTRA (master cell) and NR (secondary cell) simultaneously, with trigger coming from Evolved Packet Core (EPC).

Option 4 (aka NE-DC)

This option involves support for configuration of MDT in both NR (master cell) and E-UTRA (secondary cell) simultaneously, with trigger coming from 5G Core (5GC). This option is a more natural step to start in terms of DC scenario support since it is an evolution of the current standardization activity for MDT in 5GC and NR as a priority.

Option 7 (aka NGEN-DC)

This option is unique in the sense that it covers 5G core as well as E-UTRA which complicates in the sense that we cannot reuse the 5GC MDT triggers agreed for NR since it would contain beam specific configuration as well as the legacy LTE mechanism cannot be used since that is based on EPC.

Certain problems exist. For example, currently, MDT configuration and reporting is performed only for a single cell. In release 14 for LTE and release 15 for NR, dual connectivity support was added in 3GPP specification which allows the UE to actually have downlink and uplink transmission with two or multiple cells simultaneously. Thus, MDT reporting could also be enhanced to report the coverage and Quality of Service (QoS) aspects of the secondary cells groups configured on a UE along with other MDT measurements involving the secondary RAN nodes called secondary node. In current specification, there is no support for MDT configuration and reporting for secondary cell groups configured on a UE and thus there is a requirement for an enhancement in current MDT functionality in Release 14 along with Release 16 work on introducing MDT for NR cells.

### SUMMARY

Certain aspects of the present disclosure and their embodiments may provide solutions to these or other challenges. For example, according to certain embodiments, systems and methods are provided for configuring the Minimization of Drive Test (MDT) measurements for secondary cell groups along with the master cells group in case of dual connectivity scenarios. This includes mechanism(s) for Operations, Administration, Management (OAM)/node triggering MDT to configure the MDT trigger towards Radio Access Network (RAN) indicating the requirement for MDT measurements from secondary cell group.

According to certain embodiments, a method performed by a wireless device includes receiving, from a first network node, a first MDT configuration for a secondary cell group and applying the first MDT configuration for the secondary cell group.

According to certain embodiments, a wireless device includes processing circuitry configured to receive, from a first network node, a first MDT configuration for a secondary cell group and apply the first MDT configuration for the secondary cell group.

According to certain embodiments, a method performed by a secondary network node associated with a secondary cell group includes transmitting, to a wireless device, a MDT configuration for the secondary cell group.

According to certain embodiments, a secondary network node associated with a secondary cell group includes processing circuitry configured to transmit, to a wireless device, a MDT configuration for the secondary cell group.

According to certain embodiments, a method performed by a master network node associated with a master cell group includes receiving a first MDT configuration for a secondary cell group. The master network node determines that a wireless device supports dual connectivity and is configured with the secondary cell group and transmits the first MDT configuration for the secondary cell group.

According to certain embodiments, a master network node associated with a master cell group includes processing circuitry configured to receive a first MDT configuration for a secondary cell group. The processing circuitry is configured to determine that a wireless device supports dual connectivity and is configured with the secondary cell group and transmit the first MDT configuration for the secondary cell group.

Certain embodiments may provide one or more of the following technical advantages. For example, one technical advantage may be that certain embodiments provide support for secondary cell group MDT measurements in OAM/node triggering MDT, RAN and user equipment (UE). As another example, a technical advantage may be that certain embodiments provide support for measuring the coverage and Quality of Service (QoS) aspects of the secondary cell group.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the classification of the Minimization Drive Tests (MDT);

FIG. 2 illustrates the multiple architecture options available according to Release 15;

FIG. 3 illustrates the bearer types based on termination points;

FIG. 4 illustrates an example wireless network, according to certain embodiments;

FIG. 5 illustrates an example network node, according to certain embodiments;

FIG. 6 illustrates an example wireless device, according to certain embodiments;

FIG. 7 illustrate an example user equipment, according to certain embodiments;

FIG. 8 illustrates a virtualization environment in which functions implemented by some embodiments may be virtualized, according to certain embodiments;

FIG. 9 illustrates a telecommunication network connected via an intermediate network to a host computer, according to certain embodiments;

FIG. 10 illustrates a generalized block diagram of a host computer communicating via a base station with a user equipment over a partially wireless connection, according to certain embodiments;

FIG. 11 illustrates a method implemented in a communication system, according to one embodiment;

FIG. 12 illustrates another method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates an example method by a wireless device, according to certain embodiments;

FIG. 16 illustrates an exemplary virtual computing device, according to certain embodiments;

FIG. 17 illustrates an example method by a secondary network node, according to certain embodiments;

FIG. 18 illustrates another exemplary virtual computing device, according to certain embodiments;

FIG. 19 illustrates an example method by a master network node, according to certain embodiments; and

FIG. 20 illustrates another exemplary virtual computing device, according to certain embodiments.

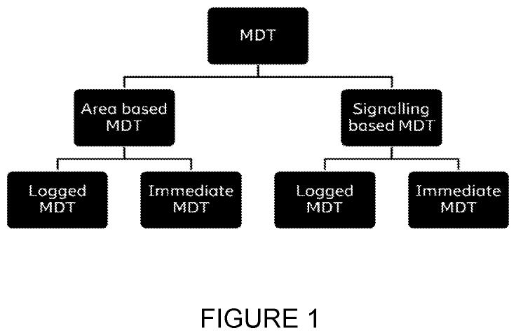

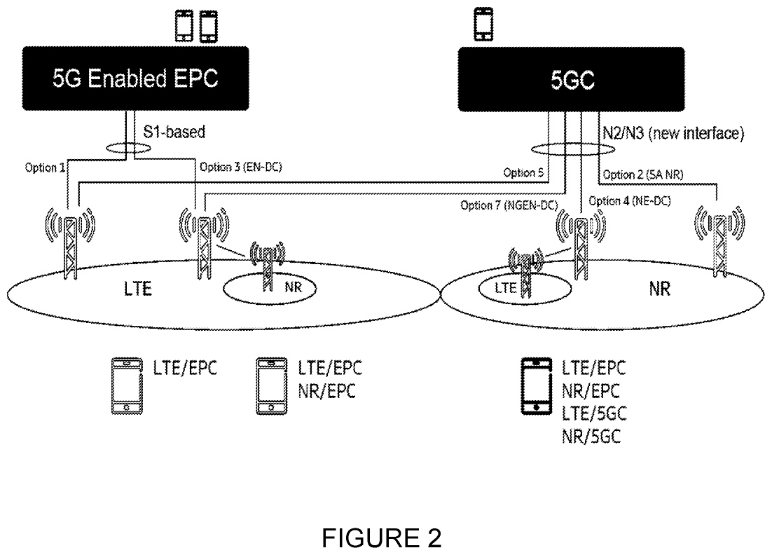

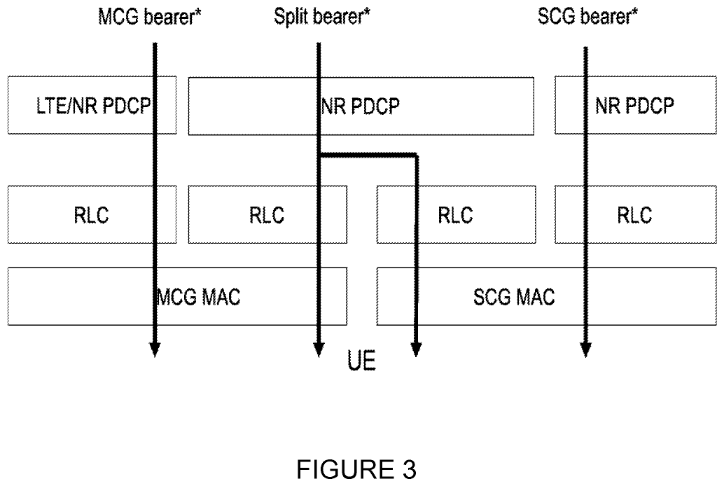

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a user equipment (UE) (directly or via another node) and/or with another network node. Examples of network nodes are NodeB, Master eNodeB (MeNB), eNodeB (ENB), a network node belonging to a Master Cell Group (MCG) or Secondary/Slave Cell Group (SCG), base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobile Management Entity (MME), etc.), Operations & Management (O&M), Operations Support System (OSS), Self Optimized Network (SON), positioning node (e.g. Evolved-Serving Mobile Location Center (E-SMLC)), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Data Assistant (PDA), Tablet, mobile terminals, smart phone, laptop embedded equipped (LEE), laptop mounted equipment (LME), Universal Serial Bus (USB) dongles, UE category M1, UE category M2, Proximity Services (ProSe UE), Vehicle-to-Vehicle (V2V) UE, Vehicle-to-Anything (V2X) UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, a method is provided to enable that RAN nodes to enhance the MDT configurations for dual connectivity scenarios including but not limited to
EN-DC
NE-DC
NG-ENDC

According to certain embodiments, a method is provided for OAM or any other network entity triggering MDT to trigger the RAN node for providing MDT measurements for secondary cell groups if the UE is configured with dual connectivity.

For example, according to certain embodiments, a method is provided for configuring the MDT measurements for secondary cell groups along with the master cells group in case of dual connectivity scenarios. This includes mechanism(s) for OAM/node triggering MDT to configure the MDT trigger towards RAN indicating the requirement for MDT measurements from secondary cell group.

According to certain embodiments, a mechanism is also provided for the RAN node to handle the MDT trigger from OAM/node triggering MDT in CU-DU split architecture as well as coordination of the MDT configuration between Master and Slave node.

According to certain embodiments, a mechanism is also provided for the UE to report the MDT measurements for the master and secondary cell groups.

### MDT Configuration for MR-DC Scenarios

According to certain embodiments, OAM or another network entity can include configuration for secondary cell group (SCG) in the MDT triggers (along with MDT trigger for MDT node) for immediate MDT.

According to certain embodiments, OAM can include a flag in the MDT trigger indicating if the MDT configuration is valid for SCG cells configured on a UE supporting MDT.

According to certain embodiments, the MDT configuration from OAM or another network entity can be common for both MCG and SCG cells or separate configurations for MCG and SCG cells respectively.

According to certain embodiments, UE only applies the configuration for secondary cell group (SCG) in the MDT trigger if it supports dual connectivity and is currently configured with a secondary cell group (SCG).

According to certain embodiments, in case only MN receive the MDT trigger and the UE is configured with MR-DC, should be able to comprehend the MDT configuration for MR-DC from OAM/network entity. In this case, there could be multiple options to handle the MDT configuration for SCG cells including but not limited to:
MN should be able to forward the SN part of the MDT configuration to SN,
Only in case of split bearer, MN performs the RAN node part of the MDT measurements for SCG cells and forwards the remaining MDT configuration to SN,
Only In case of SN terminated bearer, MN forwards the SN part of the MDT configuration to SN,
It is up to MN implementation, it if wants to forward the complete MDT configuration for SCG cells to SN or only parts of MDT configuration based on local RAN configuration.
All or selective combination of the above options.

According to certain embodiments, in MR-DC with immediate MDT, both MN and SN separately provides MDT configuration to the UE and also receive separate MDT reports from the UE.

According to certain embodiments, in MR-DC with immediate MDT, UE can combine the MN and SN MDT measurements in one report towards the Master cell group.

According to certain embodiments, in MR-DC with immediate MDT, MN can combine the MCG and SCG MDT measurements in one report towards the Trace collection entity.

According to certain embodiments, in a particular embodiment, In MR-DC with immediate MDT, UE should be able to receive separate configuration for MN and SN.

According to certain embodiments, in a particular embodiment, In MR-DC with immediate MDT, UE should be able to provide separate MDT reports for MN and SN either over SRB1/2 or SRB3.

According to certain embodiments, in a particular embodiment, for EN-DC scenario, the E-UTRA MDT configuration and MDT report is enhanced to include configuration for NR secondary cell group.

According to certain embodiments, in a particular embodiment, for NE-DC scenario, the NR MDT configuration and MDT report is enhanced to include MDT configuration for E-UTRA secondary cell group.

According to certain embodiments, in a particular embodiment, reuse the release 14 specification of MDT configuration for E-UTRA secondary cell group cells.

According to certain embodiments, in a particular embodiment, for NG-ENDC scenario, the NR MDT trigger from 5GC is reused but without beam information configuration since E-UTRA connected to 5GC does not support the beam concept.

According to certain embodiments, in a particular embodiment, for NG-ENDC scenario, MDT reporting during Inactive state is supported as in MDT reporting in NR cells.

According to certain embodiments, in another embodiment, for split RAN scenario, CU could perform parts of MDT measurements for both MCG and SCG configured towards a UE while DU would perform the UE specific MDT measurements including latency over the air.

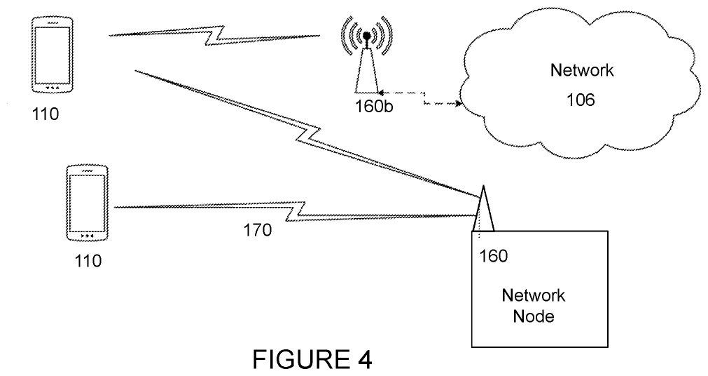

FIG. 4 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

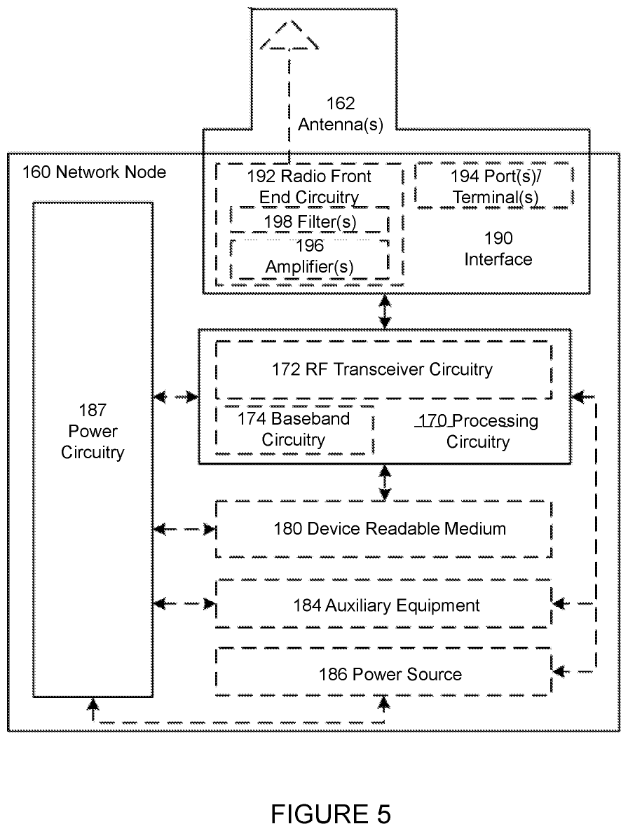

FIG. 5 illustrates an example network node, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

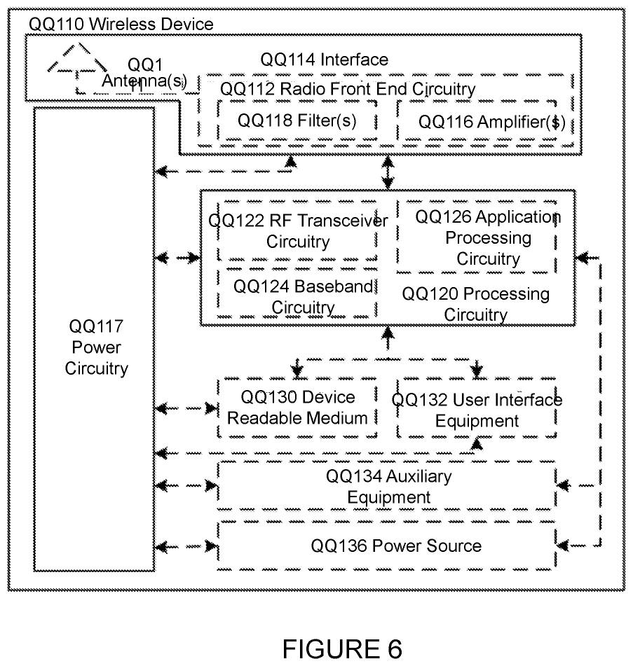

FIG. 6 illustrates an example wireless device 110, according to certain embodiments. As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

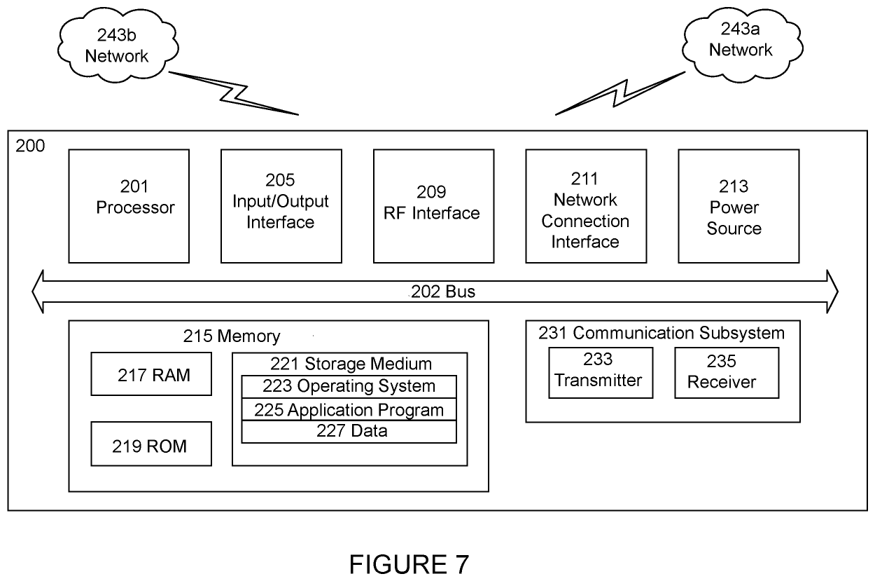

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

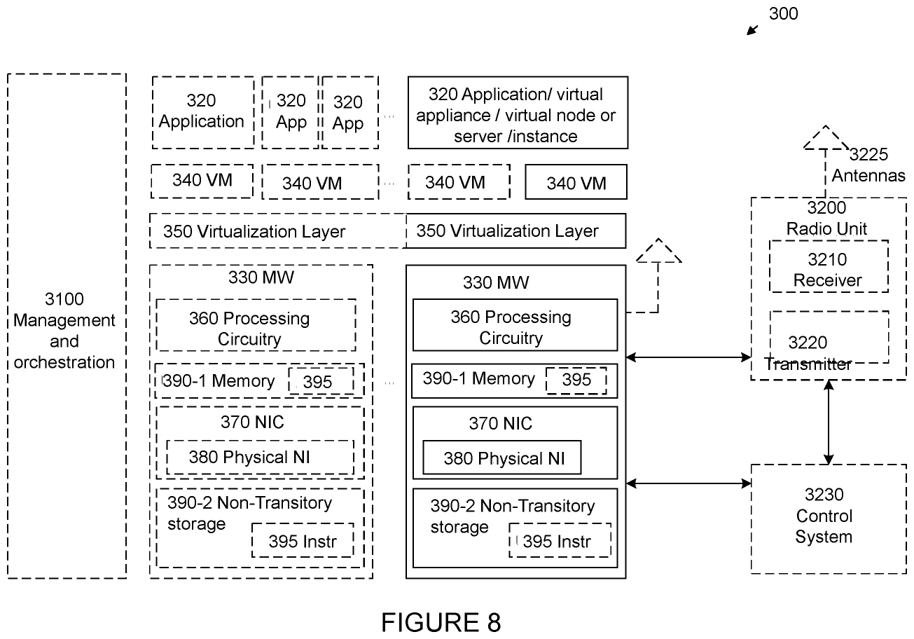

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 8.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

FIG. 9 illustrates a telecommunication network connected via an intermediate network to a host computer in accordance with some embodiments.

With reference to FIG. 9, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 9 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

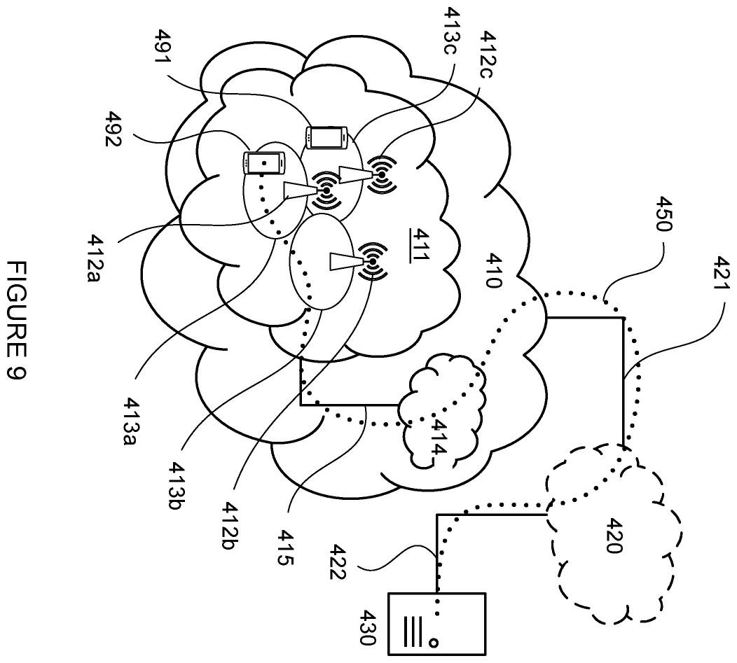

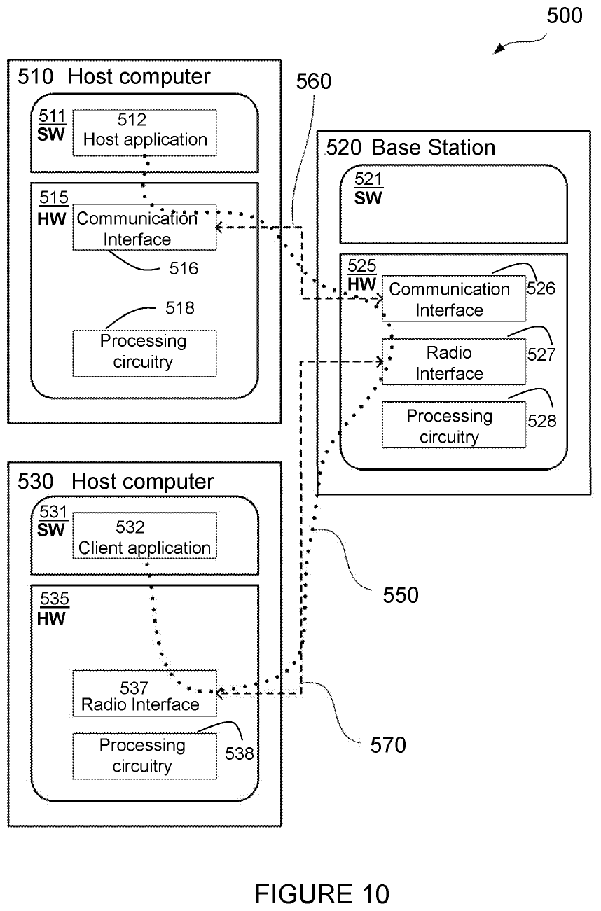

FIG. 10 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 10. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 10) served by base station 520. Communication interface 526 may be configured to facilitate connection 560 to host computer 510. Connection 560 may be direct or it may pass through a core network (not shown in FIG. 10) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 10 may be similar or identical to host computer 430, one of base stations 412a, 412b, 412c and one of UEs 491, 492 of FIG. 9, respectively. This is to say, the inner workings of these entities may be as shown in FIG. 10 and independently, the surrounding network topology may be that of FIG. 9.

In FIG. 10, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

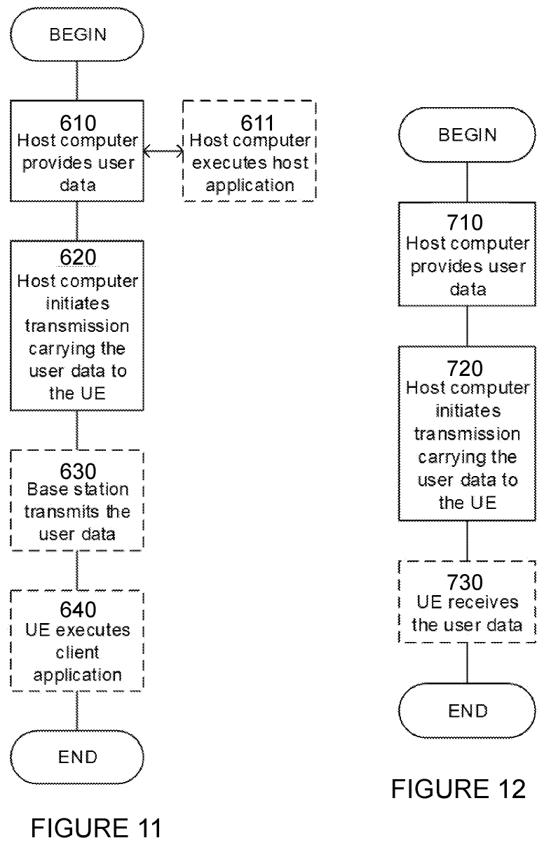

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

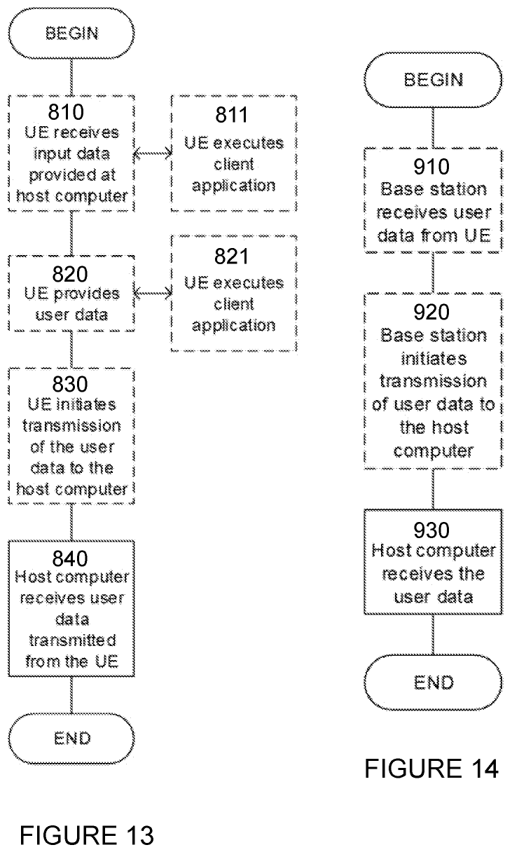

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

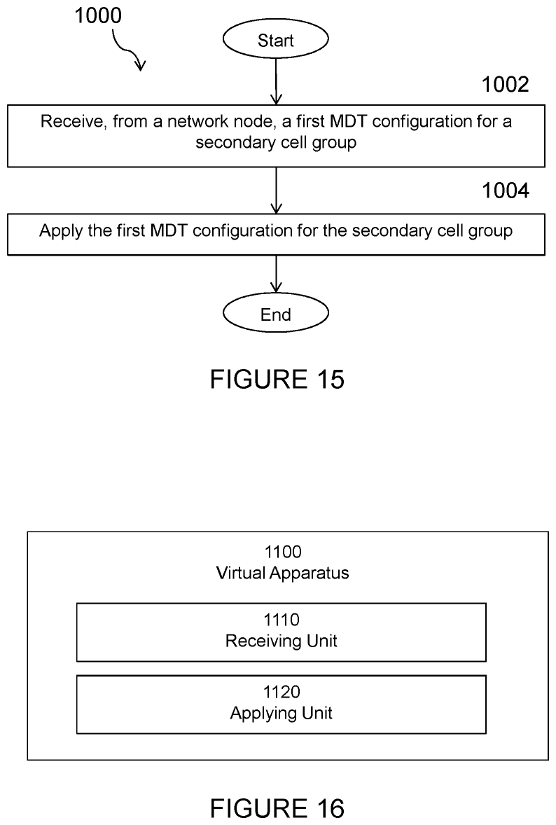

FIG. 15 depicts a method 1000 by a wireless device 110, according to certain embodiments. At step 1002, the wireless device receives, from a first network node 160, a first MDT configuration for a secondary cell group. At step 1004, the wireless device applies the first MDT configuration for the secondary cell group.

In a particular embodiment, applying the first MDT configuration for the secondary cell group includes transmitting a first MDT report associated with the secondary cell group to a secondary network node.

In a particular embodiment, the first network node 160 includes a secondary node such that the first MDT configuration for the secondary cell group is received from the secondary node.

In a particular embodiment, wireless device 110 receives, from a second network node 160 comprising a master node associated with a master cell group, a second MDT configuration for the master cell group. The wireless device 110 applies the second MDT configuration for the master cell group and transmits a second MDT report associated with the master cell group to the master node.

In a particular embodiment, the first network node 160 comprises a master node associated with a master cell group and the first MDT configuration for the secondary cell group is received from the master node. In a further particular embodiment, wireless device 110 receives, from the first network node 160 comprising the master node, a second MDT configuration for a master cell group and applies the first MDT configuration for the master cell group. Wireless device 110 transmits a second MDT report associated with the master cell group to the master node.

In a particular embodiment, first MDT configuration comprises at least one trigger for triggering MDT in the secondary cell group. In response to detecting fulfillment of the at least one MDT trigger for the secondary cell group, wireless device 110 performs MDT for the secondary cell group.

In a particular embodiment, the secondary cell group comprises a NR secondary cell group.

In a particular embodiment, the first MDT configuration for the secondary cell group comprises a configuration for immediate MDT.

In a particular embodiment, the secondary cell group includes an E-UTRA secondary cell group, and the first MDT configuration for the secondary cell group includes a MDT configuration for the E-UTRA secondary cell group.

FIG. 16 illustrates a schematic block diagram of a virtual apparatus 1100 in a wireless network (for example, the wireless network shown in FIG. 4). The apparatus may be implemented in a wireless device or network node (e.g., wireless device 110 or network node 160 shown in FIG. 4). Apparatus 1100 is operable to carry out the example method described with reference to FIG. 15 and possibly any other processes or methods disclosed herein. It is also to be understood that the method of FIG. 15 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1110, applying unit 1120, and any other suitable units of apparatus 1100 to perform corresponding functions according one or more embodiments of the present disclosure.

According to certain embodiments, receiving unit 1110 may perform certain of the receiving functions of the apparatus 1100. For example, receiving unit 1110 may receive from a network node 160, a first MDT configuration for a secondary cell group.

According to certain embodiments, applying unit 1120 may perform certain of the applying functions of the apparatus 1100. For example, applying unit 1120 may apply the first MDT configuration for the secondary cell group.

The term or module unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

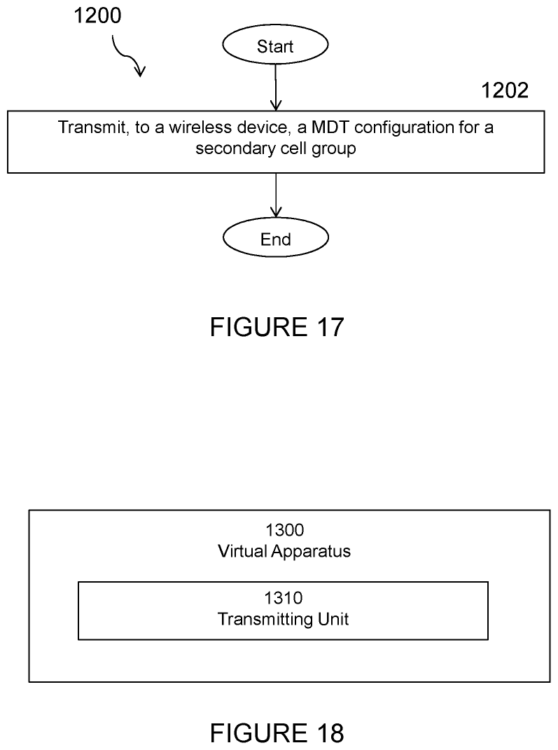

FIG. 17 depicts a method 1200 by a secondary network node 160 associated with a secondary cell group, according to certain embodiments. At step 1202, the network node 160 transmits, to a wireless device 110, a MDT configuration for the secondary cell group.

In a particular embodiment, the secondary network node 160 receives a MDT report that includes MDT data associated with the secondary cell group from the wireless device.

In a particular embodiment, the MDT report further includes MDT data with a master cell group.

In a particular embodiment, the MDT configuration includes at least one trigger for triggering MDT in the secondary cell group.

In a particular embodiment, the MDT configuration includes a flag in the MDT triggers. The flag may indicate that the MDT configuration is valid for the secondary cell group.

In a particular embodiment, the secondary network node 160 receives the MDT configuration from an OAM node.

In a particular embodiment, the secondary network node 160 receives the MDT configuration from a master node associated with a master cell group.

In a particular embodiment, the secondary cell group comprises a NR secondary cell group.

In a particular embodiment, the MDT configuration for the secondary cell group includes a configuration for immediate MDT.

In a particular embodiment, the secondary cell group comprises an E-UTRA secondary cell group, and the MDT configuration for the secondary cell group includes a MDT configuration for the E-UTRA secondary cell group.

FIG. 18 illustrates a schematic block diagram of a virtual apparatus 1300 in a wireless network (for example, the wireless network shown in FIG. 4). The apparatus may be implemented in a wireless device or network node (e.g., wireless device 110 or network node 160 shown in FIG. 4). Apparatus 1300 is operable to carry out the example method described with reference to FIG. 17 and possibly any other processes or methods disclosed herein. It is also to be understood that the method of FIG. 18 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1310 and any other suitable units of apparatus 1300 to perform corresponding functions according one or more embodiments of the present disclosure.

According to certain embodiments, transmitting unit 1310 may perform certain of the transmitting functions of the apparatus 1300. For example, transmitting unit 1310 may transmit, to a wireless device 110, a MDT configuration for a secondary cell group.

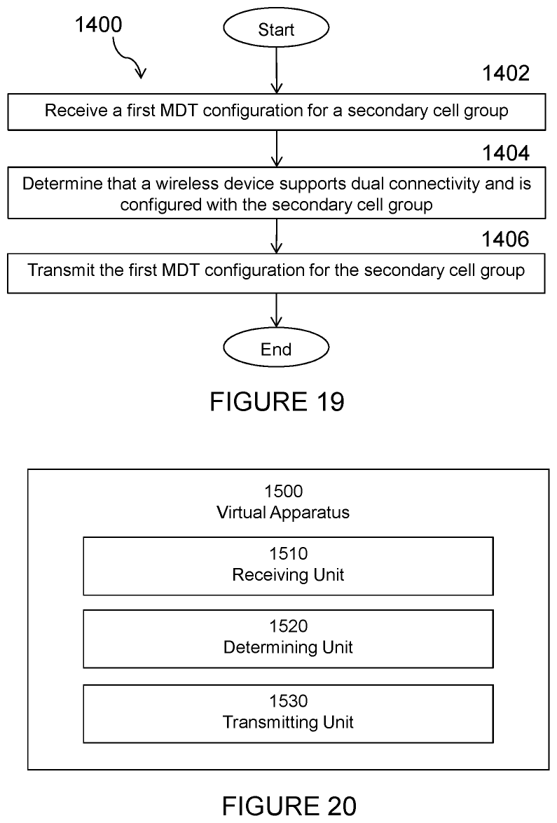

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. FIG. 19 depicts a method 1400 by a master network node 160 associated with a master cell group, according to certain embodiments. At step 1402, the master network node 160 receives a first MDT configuration for a secondary cell group. At step 1404, the master network node 160 determines that a wireless device 160 supports dual connectivity and is configured with the secondary cell group. At step 1404, the master network node 160 transmits the first MDT configuration for the secondary cell group.

In a particular embodiment, when transmitting the first MDT configuration for the secondary cell group, the master network node 160 transmits the first MDT configuration to a secondary network node 160 associated with the secondary cell group.

In a particular embodiment, when transmitting the first MDT configuration for the secondary cell group, the master network node 160 transmits the first MDT configuration to the wireless device 110 that is configured with the secondary cell group.

In a particular embodiment, the first MDT configuration includes at least one trigger for triggering MDT in the secondary cell group.

In a particular embodiment, the MDT configuration includes a flag in the MDT triggers. The flag may indicate that the MDT configuration is valid for the secondary cell group.

In a particular embodiment, the master network node 160 receives the MDT configuration from an OAM node.

In a particular embodiment, the master network node 160 receives, from the wireless device 110, a first MDT report comprising MDT data associated with the secondary cell group.

In a particular embodiment, the master network node 160 transmits, to the wireless device 110, a second MDT configuration for a master cell group and receives, from the wireless device 110, a second MDT report includes MTD data associated with the master cell group.

In a particular embodiment, the first MDT configuration for the secondary cell group is the same as the second MDT configuration for the master cell group.

In a particular embodiment, the secondary cell group comprises a NR secondary cell group.

In a particular embodiment, the secondary cell group includes an E-UTRA secondary cell group, and the first MDT configuration includes a MDT configuration for the E-UTRA secondary cell group.

FIG. 20 illustrates a schematic block diagram of a virtual apparatus 1500 in a wireless network (for example, the wireless network shown in FIG. 4). The apparatus may be implemented in a wireless device or network node (e.g., wireless device 110 or network node 160 shown in FIG. 4). Apparatus 1500 is operable to carry out the example method described with reference to FIG. 19 and possibly any other processes or methods disclosed herein. It is also to be understood that the method of FIG. 19 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1510, determining unit 1520, transmitting unit 1530, and any other suitable units of apparatus 1500 to perform corresponding functions according one or more embodiments of the present disclosure.

According to certain embodiments, receiving unit 1510 may perform certain of the receiving functions of the apparatus 1500. For example, receiving unit 1510 may receive a first MDT configuration for a secondary cell group.

According to certain embodiments, determining 1520 may perform certain of the determining functions of the apparatus 1500. For example, determining unit 1520 may determine that a wireless device 160 supports dual connectivity and is configured with the secondary cell group.

According to certain embodiments, transmitting unit 1530 may perform certain of the transmitting functions of the apparatus 1500. For example, transmitting unit 1530 may transmit the first MDT configuration for the secondary cell group.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Example Embodiments

Example Embodiment 1. A method performed by a wireless device, the method comprising: receiving, from a network node, a MDT configuration for a secondary cell group; and applying the MDT configuration for the secondary cell group.

Example Embodiment 2. The method of Embodiment 1, wherein the MDT configuration comprises at least one trigger for triggering MDT in the secondary cell group.

Example Embodiment 3. The method of Embodiment 1, wherein the MDT configuration comprises a flag in the MDT triggers.

Example Embodiment 4. The method of any one of Embodiments 1 to 3, further comprising: in response to detecting fulfillment of the at least one MDT trigger for the secondary cell group, performing MDT for the secondary cell group.

Example Embodiment 5. The method of any one of Embodiments 1 to 4, wherein applying the MDT configuration for the secondary cell group further comprises: determining that the wireless device supports dual connectivity and is currently configured with the secondary cell group; and in response to determining that the wireless device supports dual connectivity and is configured with the secondary cell group, applying the MDT configuration for the secondary cell group.

Example Embodiment 6. The method of any one of Embodiments 1 to 5, wherein the MDT configuration includes slave node-related measurements, the slave node-related measurements being not supported for logged MDT when the wireless device is inactive.

Example Embodiment 7. The method of any one of Embodiments 1 to 6, wherein the network node comprises a slave node such that the MDT configuration for a secondary cell group is received from the slave node.

Example Embodiment 8. The method of Embodiment 7, further comprising receiving from another network node comprising a master node, a MDT configuration for a master cell group.

Example Embodiment 9. The method of any one of Embodiments 1 to 8, wherein applying the MDT configuration for the secondary cell group comprises transmitting a MDT report associated with the secondary cell group to the network node.

Example Embodiment 10. The method of any one of Embodiments 1 to 9, further comprising applying another MDT configuration for a master cell group and transmitting another MDT report associated with the master cell group to another network node operating as a master node.

Example Embodiment 11. The method of any one of Embodiments 1 to 10, wherein the secondary cell group comprises a NR secondary cell group.

Example Embodiment 12. The method of any one of Embodiments 1 to 10, wherein the secondary cell group comprises a E-UTRA secondary cell group.

Example Embodiment 13. The method of any one of Embodiments 1 to 10, wherein the MDT configuration for the secondary cell group comprises a MDT configuration for E-UTRA secondary group cells.

Example Embodiment 14. The method of any one of Embodiments 1 to 13, wherein the MDT configuration for the secondary cell group is common to a master cell group.

Example Embodiment 15. The method of any one of Embodiments 1 to 14, wherein the network node is a master node and the MDT configuration for the secondary cell group is received from the master node.

Example Embodiment 16. The method of any one of Embodiments 1 to 15, further comprising transmitting a MDT report that comprises MDT data associated with the secondary cell group and MDT data associated with a master cell group.

Example Embodiment 17. A method performed by a base station, the method comprising: transmitting, to a wireless device, a MDT configuration for a secondary cell group.

Example Embodiment 18. The method of Embodiment 17, wherein the MDT configuration comprises at least one trigger for triggering MDT in the secondary cell group.

Example Embodiment 19. The method of Embodiment 17, wherein the MDT configuration comprises a flag in the MDT triggers.

Example Embodiment 20. The method of any one of Embodiments 17 to 19, wherein the network node is a OAM.

Example Embodiment 21. The method of any one of Embodiments 17 to 19, wherein the network node is a secondary node associated with the secondary cell group.

Example Embodiment 22. The method of Embodiment 21, wherein the network node receives the MDT configuration from a master node.

Example Embodiment 23. The method of any one of Embodiments 17 to 22, further comprising: determining that the wireless device supports dual connectivity and is currently configured with the secondary cell group.

Example Embodiment 24. The method of any one of Embodiments 17 to 23, wherein the MDT configuration includes slave node-related measurements, the slave node-related measurements not being supported for logged MDT when the wireless device is inactive.

Example Embodiment 25. The method of any one of Embodiments 17 to 24, wherein the network node comprises a slave node.

Example Embodiment 26. The method of any one of Embodiments 17 to 25, further comprising receiving a MDT report associated with the secondary cell group from the wireless device.

Example Embodiment 27. The method of any one of Embodiments 17 to 26, wherein the secondary cell group comprises a NR secondary cell group.

Example Embodiment 28. The method of any one of Embodiments 17 to 26, wherein the secondary cell group comprises a E-UTRA secondary cell group.

Example Embodiment 29. The method of any one of Embodiments 17 to 26, wherein the MDT configuration for the secondary cell group comprises a MDT configuration for E-UTRA secondary group cells.

Example Embodiment 30. The method of any one of Embodiments 17 to 29, wherein the MDT configuration for the secondary cell group is common to a master cell group.

Example Embodiment 31. The method of any one of Embodiments 17 to 30, wherein the network node is a master node.

Example Embodiment 32. The method of any one of Embodiments 17 to 31, further comprising receiving a MDT report that comprises MDT data associated with the secondary cell group and MDT data associated with a master cell group.

Example Embodiment 33. A wireless device for improving network efficiency, the wireless device comprising: processing circuitry configured to perform any of the steps of any of Example Embodiments 1 to 16; and power supply circuitry configured to supply power to the wireless device.

Example Embodiment 34. A base station for improving network efficiency, the base station comprising: processing circuitry configured to perform any of the steps of any of Example Embodiments 17 to 32; power supply circuitry configured to supply power to the wireless device.

Example Embodiment 35. A user equipment (UE) for improving network efficiency, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Example Embodiments 1 to 16; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 36. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of Example Embodiments 17 to 32.

Example Embodiment 37. The communication system of the pervious embodiment further including the base station.

Example Embodiment 38. The communication system of the previous 2 embodiments, further including the UE, wherein the UE is configured to communicate with the base station.

Example Embodiment 39. The communication system of the previous 3 embodiments, wherein: the processing circuitry of the host computer is configured to execute a host application, thereby providing the user data; and the UE comprises processing circuitry configured to execute a client application associated with the host application.

Example Embodiment 40. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of Example Embodiments 17 to 32.

Example Embodiment 41. The method of the previous embodiment, further comprising, at the base station, transmitting the user data.

Example Embodiment 42. The method of the previous 2 embodiments, wherein the user data is provided at the host computer by executing a host application, the method further comprising, at the UE, executing a client application associated with the host application.

Example Embodiment 43. A user equipment (UE) configured to communicate with a base station, the UE comprising a radio interface and processing circuitry configured to performs the of the previous 3 embodiments.

Example Embodiment 44. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of Example Embodiments 1 to 16.

Example Embodiment 45. The communication system of the previous embodiment, wherein the cellular network further includes a base station configured to communicate with the UE.

Example Embodiment 46. The communication system of the previous 2 embodiments, wherein: the processing circuitry of the host computer is configured to execute a host application, thereby providing the user data; and the UE's processing circuitry is configured to execute a client application associated with the host application.

Example Embodiment 47. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of Example Embodiments 1 to 16.

Example Embodiment 48. The method of the previous embodiment, further comprising at the UE, receiving the user data from the base station.

Example Embodiment 49. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of Example Embodiments 1 to 16.

Example Embodiment 50. The communication system of the previous embodiment, further including the UE.

Example Embodiment 51. The communication system of the previous 2 embodiments, further including the base station, wherein the base station comprises a radio interface configured to communicate with the UE and a communication interface configured to forward to the host computer the user data carried by a transmission from the UE to the base station.

Example Embodiment 52. The communication system of the previous 3 embodiments, wherein: the processing circuitry of the host computer is configured to execute a host application; and the UE's processing circuitry is configured to execute a client application associated with the host application, thereby providing the user data.

Example Embodiment 53. The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Example Embodiment 54. A method implemented in a communication system including a host computer, a base station and a user equipment (UE), the method comprising: at the host computer, receiving user data transmitted to the base station from the UE, wherein the UE performs any of the steps of any of Example Embodiments 1 to 16.

Example Embodiment 55. The method of the previous embodiment, further comprising, at the UE, providing the user data to the base station.

Example Embodiment 56. The method of the previous 2 embodiments, further comprising: at the UE, executing a client application, thereby providing the user data to be transmitted; and at the host computer, executing a host application associated with the client application.

Example Embodiment 57. The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

Example Embodiment 58. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of Example Embodiments 17 to 32.

Example Embodiment 59. The communication system of the previous embodiment further including the base station.

Example Embodiment 60. The communication system of the previous 2 embodiments, further including the UE, wherein the UE is configured to communicate with the base station.

Example Embodiment 62. The communication system of the previous 3 embodiments, wherein: the processing circuitry of the host computer is configured to execute a host application; the UE is configured to execute a client application associated with the host application, thereby providing the user data to be received by the host computer.

Example Embodiment 63. A method implemented in a communication system including a host computer, a base station and a user equipment (UE), the method comprising: at the host computer, receiving, from the base station, user data originating from a transmission which the base station has received from the UE, wherein the UE performs any of the steps of any of Example Embodiments 1 to 16.

Example Embodiment 64. The method of the previous embodiment, further comprising at the base station, receiving the user data from the UE.

Example Embodiment 65. The method of the previous 2 embodiments, further comprising at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
5GS 5G System
5QI 5G QoS Identifier
ABS Almost Blank Subframe
AN Access Network
AN Access Node
ARQ Automatic Repeat Request
AS Access Stratum
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CN Core Network
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eMBB Enhanced Mobile BroadBand
eNB E-UTRAN NodeB
ePDCCH enhanced Physical Downlink Control Channel
EPS Evolved Packet System
E-SMLC evolved Serving Mobile Location Center
E-UTRA Evolved UTRA
E-UTRAN Evolved Universal Terrestrial Radio Access Network
FDD Frequency Division Duplex
FFS For Further Study
GERAN GSM EDGE Radio Access Network
gNB gNode B (a base station in NR; a Node B supporting NR and connectivity to NGC)
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NGC Next Generation Core
NG-RAN Node either a gNB or an ng-eNB
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PS Packet Switched
PSS Primary Synchronization Signal
PUCCH Physical Uplink Control Channel
PUSCH Physical Uplink Shared Channel
RACH Random Access Channel
QAM Quadrature Amplitude Modulation
RAB Radio Access Bearer
RAN Radio Access Network
RANAP Radio Access Network Application Part
RAN Node an eNB or NG-RAN node (either a gNB or an ng-eNB)
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
RWR Release with Redirect
SCH Synchronization Channel
SCell Secondary Cell
SCS Subcarrier Spacing
SDU Service Data Unit
SFN System Frame Number
SGW Serving Gateway
SI System Information
SIB System Information Block
SNR Signal to Noise Ratio
S-NSSAI Single Network Slice Selection Assistance Information
SON Self Optimized Network
SS Synchronization Signal
SSS Secondary Synchronization Signal
TBS Transport Block Size
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

### CONCLUSION

### Additional Information

In the study item, “Study on RAN-centric data collection and utilization for LTE and NR (FS_LTE_NR_data_collect)”, Minimization of Drive Tests (MDT) is one of the use cases to be studied for NR and LTE enhancement.

In RAN2 #105, the following high-level agreements were made pertaining to support of MDT in NR:
Logged MDT, immediate MDT and accessibility report should be supported for NR MDT. LTE MDT measurements/failures could be the baseline
Logged MDT should also be supported for RRC_INACTIVE and RRC_IDLE.
Management based and signalling based trace procedure in LTE can be reused in NG-RAN MDT.
   Since, the baseline agreements on NR MDT have been made now, we can discuss the dual connectivity aspects of MDT as well. In this paper, we discuss the details about the MDT support in different type of Dual connectivity scenarios and associated complexity, specifically:
Use case and benefits of MDT reporting in EN-DC.
EN-DC configuration and reporting
Support of MDT variants in EN-DC
Scenario covering SUL
   OAM is Aware about the Support for Dual Connectivity in a Specific RAN Node but OAM does not have Visibility about the Dual Connectivity Configuration on Individual UE

The simplest solution to this issue is that the OAM send an MDT configuration including dual connectivity if the RAN node supports dual connectivity. If the UE receives MDT configuration when it is configured with dual connectivity, it would apply the MDT configuration for secondary cell group (SCG) cells otherwise it would ignore the MDT configuration for secondary cell group (SCG) cells.

Accordingly, it is proposed that OAM can include configuration for secondary cell group (SCG) in the MDT triggers for immediate MDT.

Accordingly, it is proposed that UE only applies the configuration for secondary cell group (SCG) in the MDT triggers if it supports dual connectivity and is currently configured with a secondary cell group (SCG)

### Configuration of MDT Configuration to UE Via MN SN or Both

The next important aspect is how the MDT configuration with DC consideration is send to the UE. Before assessing the configuration option for MDT in MR-DC scenarios, it is important to assess the measurement quantities currently available in MDT for both logged and immediate MDT as shown in Table 2 above.

Logged MDT only involves UE specific measurements but Immediate MDT involves measurements from both UE and the RAN node, specifically measurements M4-M7 are specific to RAN node.

Logged MDT only involves UE specific measurements but Immediate MDT involves measurements from both UE and the RAN node, specifically measurements M4-M7 are specific to RAN node.

Thus, specifically for Immediate MDT in MR-DC, we need to configure both RAN nodes contribute towards calculating the MDT measurements.

Now, if the options available to configure the MDT on UE in MR-DC scenarios are considered, there are multiple options available:
MDT configuration is always provided by MN
MDT configuration for MN is provided by MN and SN provides its respective configuration to the UE
Flexible approach for MDT configuration in DC scenarios where SN can be configured to provide MDT configuration based on network preference
   The first option that the complete MDT configuration including dual connectivity aspect is always provided by MN is the simplest approach since it avoids the complexity to coordinate between MN and SN on which node would configure the MDT configuration for SN towards the UE. There are some potential issues in case of MN configuring reports for SN on UE including:
MN needs to provide MDT configuration for SN, potentially on another RAT, i.e. NE-DC or EN-DC scenarios. The trigger conditions and the configuration parameters could be different in this case which needs to be supported by MN.
In case of SN terminated bearer, SRB is terminated directly on the SN so in this case, the measurements M4-M7 needs to be specifically measured at SN since the PDCP for SN is separate from MN. If the SN need to report these measurements to MN always, it involves extra overhead in MN-SN signaling and coordination. It might be applicable in split bearer scenario that part of M4-M7 can be measured in the MN since the PDCP is located in MN but then we need to have a separate implementation for both split bearer and SN terminated bearer.

It is observed that if MDT configuration is always provided by MN, there is no coordination requirement between MN and SN regarding which node would configure the MDT configuration for SN.

It is observed that if MDT configuration is always provided by MN,
MN needs to provide MDT configuration for the SN, potentially on another RAT
In case of SN terminated bearer, SRB is terminated directly on the SN so in this case, the measurements M4-M7 needs to be specifically measured at SN since the PDCP for SN is separate from MN.
Requires a separate implementation for both split bearer and SN terminated bearer.
   The second and third option provides more flexibility in terms of MN and SN coordination and also cover the scenario of SN terminated bearer measurements. In this case, MN and SN can perform MDT measurements independently but at the cost of more complexity in terms of MN-SN coordination for MDT configuration and also sharing SN MDT reports with MN.

It is observed that MDT configuration by both MN and SN covers both the split bearer and SN terminated bearer scenario and also provides more flexibility to independently configure MDT reports for MN and SN.

In case of only MN providing configuration for both MN and SN, MN needs to coordinate with SN for collecting measurements M4-M7 in case of SN terminated bearer while it would receive the measurements M1, M2, M3m M8 and M9 directly from the UE. This would extra complexity since depending on if it is split bearer or SN terminated bearer, MN needs to collect different measurements from SN and then merge it into measurements received for SN from UE.

It is observed that, in case of SN terminated bearer with MN only configuring MDT, MN needs to collect multiple MDT measurements from SN and then merge it into measurements received for SN from UE to generate the complete SN report.

Thus, only MN configuring MDT configuring for SN would involve significant coordination effort between MN and SN for MDT reports along with the complexity to merge the MDT measurements for SN from UE.

In case, only MN receive the MDT trigger and the UE is configured with MR-DC, MN should be able to forward the MDT configuration to SN.

It is proposed that, in case only MN receive the MDT trigger and the UE is configured with MR-DC, MN should be able to forward the MDT configuration to SN.

### Trigger Type Support in MDT for MR DC

Another aspect to consider is the support for SN related measurements during logged measurements. First a brief overview of the types of MDT based on RRC state.

### MDT Types Based on RRC States: Logged MDT and Immediate MDT

In general, there are two types of MDT measurement logging, i.e., Logged MDT and Immediate MDT.

### Logged MDT

A UE is configured to perform periodical MDT logging during RRC_IDLE state after receiving the MDT configurations from the network. The UE shall report the DL pilot strength measurements (RSRP/RSRQ) together with time information, detailed location information if available, and WLAN, Bluetooth to the network using the UE information framework when it moves back to RRC_CONNECTED state. The DL pilot strength measurement of Logged MDT is collected based on the existing measurements required for cell reselection purpose, without imposing UE to perform additional measurements. Table 1, shown above, includes measurement logging for Logged MDT.

### Immediate MDT

Measurements for Immediate MDT purpose can be performed by RAN and UE. There are a number of measurements (M1-M9 defined in TS 37.320) which are specified for RAN measurements and UE measurements. For UE measurements, the MDT configuration is based on the existing RRC measurement procedures for configuration and reporting with some extensions for location information.

The measurement quantities for Immediate MDT are in the Table 2, shown above.

Currently, the UE only measures on the MN cell when it is in Inactive or Idle state so the SN configuration during logged measurements does not add any value.

It is observed that UE only measures on the MN cell when it is in Inactive or Idle state so the SN configuration during logged measurements does not add any value.

On the other hand, UE can measure the SN measurements during connected state so MR-DC measurements in immediate MDT should be supported.

Accordingly, it is proposed that MDT configuration including SN related measurements is not support for logged MDT.

Accordingly, it is proposed that in MR-DC with immediate MDT, both MN and SN separately provides MDT configuration to the UE and receive MDT reports from the UE.

Accordingly, it is proposed that in MR-DC with immediate MDT, UE should be able to receive separate configuration for MN and SN.

Accordingly, it is proposed that in MR-DC with immediate MDT, UE should be able to provide separate MDT reports for MN and SN either over SRB1/2 or SRB3.

Accordingly, it is proposed that based on the above considerations, we would assess the multiple DC scenarios for release 15 below.

### Option 3 (aka EN-DC)

This option involves support for configuration of MDT in both E-UTRA (master cell) and NR (secondary cell) simultaneously, with trigger coming from EPC. Since, the trigger is coming from EPC and we already have standardized procedure defined for MDT trigger, the only delta in the MDT trigger would be to add MDT configuration for secondary cell groups which in this case would be for NR cell.

It is observed that Option 3 involves a delta in the MDT trigger to add MDT configuration for NR secondary cell groups

It is observed that from reporting point of view, UE also needs to enhanced the MDT report to include measurements for secondary cell group.

It is observed that Option 3 involves a delta in the MDT report to add MDT measurements for NR secondary cell groups.

Accordingly, it is proposed to enhance the E-UTRA MDT configuration and MDT report to include configuration for NR secondary cell group.

### Option 4 (aka NE-DC)

This option involves support for configuration of MDT in both NR (master cell) and E-UTRA (secondary cell) simultaneously, with trigger coming from 5GC. This option is a more natural step to start in terms of DC scenario support since it is an evolution of the current standardization activity for MDT in 5GC and NR as a priority.

It is observed that NE-DC is a natural step to start in terms of DC scenario support since it is an evolution of the current standardization activity for MDT in 5GC and NR as a priority.

Since, the secondary cell group in case of NE-DC would be E-UTRA cell/cells, there would no beam specific information that needs to be included in MDT configuration but rather the release 14 specification of MDT configuration for E-UTRA cell could be reused.

Accordingly it is proposed to enhance the NR MDT configuration and MDT report to include configuration for E-UTRA secondary cell group.

Accordingly, it is proposed to reuse the release 14 specification of MDT configuration for E-UTRA secondary cell group cells.

### Option 7 (aka NGEN-DC)

This option is unique in the sense that it covers 5G core as well as E-UTRA which complicates in the sense that we cannot reuse the 5GC MDT triggers agreed for NR since it would contain beam specific configuration as well as the legacy LTE mechanism cannot be used since that is based on EPC. Thus, this option requires to first standardize the MDT mechanism for option 5 (LTE connected to 5GC) and then the dual connectivity scenario. Since, option 5 comes together with LTE, it should be treated once the MDT mechanism is standardized.

It is observed that, for option 5, we cannot reuse the 5GC MDT triggers agreed for NR since it would contain beam specific configuration as well as the legacy LTE mechanism cannot be used since that is based on EPC.

Accordingly it is proposed that MDT mechanism for Option 7 should be considered after concluding MDT for option 5.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a wireless device, the method comprising:
receiving, from a first network node, a first Minimization Drive Test, MDT, configuration for a secondary cell group; and
applying the first MDT configuration for the secondary cell group.

2. The method of claim 1, wherein applying the first MDT configuration for the secondary cell group comprises transmitting a first MDT report associated with the secondary cell group to a secondary network node.

3. The method of claim 1, wherein the first network node comprises a secondary node such that the first MDT configuration for the secondary cell group is received from the secondary node.

4. The method of any one of claim 3, further comprising:
receiving, from a second network node comprising a master node associated with a master cell group, a second MDT configuration for the master cell group, and
applying the second MDT configuration for the master cell group; and
transmitting a second MDT report associated with the master cell group to the master node.

5. The method of claim 1, wherein the first network node comprises a master node associated with a master cell group and the first MDT configuration for the secondary cell group is received from the master node.

6. The method of claim 5, further comprising:
receiving, from the first network node comprising the master node, a second MDT configuration for a master cell group;
applying the first MDT configuration for the master cell group; and
transmitting a second MDT report associated with the master cell group to the master node.

7. The method of claim 1, wherein the first MDT configuration comprises at least one trigger for triggering MDT in the secondary cell group, and the method further comprises, in response to detecting fulfillment of the at least one MDT trigger for the secondary cell group, performing MDT for the secondary cell group.

8. The method of claim 1, wherein the secondary cell group comprises a NR secondary cell group.

9. The method of claim 1, wherein the first MDT configuration for the secondary cell group comprises a configuration for immediate MDT.

10. The method of claim 1, wherein the secondary cell group comprises a Evolved Universal Terrestrial Radio Access, E-UTRA, secondary cell group, and the first MDT configuration for the secondary cell group comprises a MDT configuration for the E-UTRA secondary cell group.

11.-31. (canceled)

32. A wireless device comprising:
processing circuitry configured to:
receive, from a first network node, a first Minimization Drive Test, MDT, configuration for a secondary cell group; and
apply the first MDT configuration for the secondary cell group.

33. The wireless device of claim 32, wherein the processing circuitry configured to apply the first MDT configuration for the secondary cell group comprises the processing circuitry configured to transmit a first MDT report associated with the secondary cell group to a secondary network node.

34.-37. (canceled)

38. The wireless device of claim 32, wherein the first network node comprises a secondary node such that the first MDT configuration for the secondary cell group is received from the secondary node.

39. The wireless device of claim 38, wherein the processing circuitry is further configured to:
receive, from a second network node comprising a master node associated with a master cell group, a second MDT configuration for the master cell group, and
apply the second MDT configuration for the master cell group; and
transmit a second MDT report associated with the master cell group to the master node.

40. The wireless device of claim 32, wherein the first network node comprises a master node associated with a master cell group and the first MDT configuration for the secondary cell group is received from the master node.

41. The wireless device of claim 40, wherein the processing circuitry is further configured to:
receive, from the first network node comprising the master node, a second MDT configuration for a master cell group;
apply the first MDT configuration for the master cell group; and
transmit a second MDT report associated with the master cell group to the master node.
